(19) United States
(12) Patent Application Publication
(10) Pub. No.: US 2009/0200875 A1
(43) Pub. Date: Aug. 13, 2009

(54) Apparatus for supporting design of semiconductor integrated circuit device and method for designing semiconductor integrated circuit device

(75) Inventor: Yuki Higuchi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/320,881

(22) Filed: Feb. 6, 2009

(30) Foreign Application Priority Data
Feb. 7, 2008 (JP) 2008-027535

(51) Int. Cl. H01H 83/00; G06F 17/50

(52) U.S. Cl. 307/125; 716/11

(57) ABSTRACT

A semiconductor integrated circuit device includes: a first power supply region, power supply to which is controlled; and a second power supply region connected with a first power supply region. The first power supply region includes: a floating preventing circuit configured to fix an output voltage from the first power supply region to the second power supply region to a ground voltage in synchronization with stop of power supply.

### INCORPORATION BY REFERENCE

This patent application claims priority on convention based on Japanese Patent Application 2008-027535. The disclosure thereof is incorporated herein by reference.

### BACKGROUND OF THE INVENTION

1. Field of the Invention

The present invention relates to a semiconductor integrated circuit device having a plurality of power supply regions, a method for designing the same, and an apparatus for supporting design of the same.

2. Description of Related Art

In recent years, due to employment of a finer process in a semiconductor manufacturing process, a consumed current amount in a circuit non-operation state increases and is not negligible, compared with the consumed current in a circuit operation state. For this reason, a method is known in which a region for a semiconductor integrated circuit device is divided into a plurality of power supply regions and the power supply to a region for a circuit block in the non-operation state is stopped by using a switch, so that consumed current amount of the whole semiconductor integrated circuit device is reduced.

However, when a power supply stopped region to which power is not supplied is connected to another power supply region, an output signal from the power supply stopped region to another power supply region indicates an indefinite value (floating state). For this reason, the indefinite signal is supplied to the power supply region to which power is supplied. Such an indefinite signal causes an unexpected operation in the circuit. Furthermore, a through-current due to the indefinite signal may flow between the power supply regions, to increase a consumed current amount.

Although the above problem can be prevented by using pull-up and pull-down resistors, a current steadily flows through the resistors. For this reason, in Japanese Patent Application Publication (JP-P2004-248143A: PTL1), a floating preventing circuit is used to prevent the indefinite signal.

Referring to FIGS. 1 and 2, a semiconductor integrated circuit device described in PTL1 will be described. FIG. 1 is a block diagram showing a configuration of the semiconductor integrated circuit device described in PTL1. Referring to FIG. 1, the semiconductor integrated circuit device has circuit blocks 1 and 3, a floating preventing circuit 2 and a switch 4. The switch 4 (PMOS transistor) controls connection between a power supply line VDD1 (higher voltage level) and a power supply line VDD2 in response to a sleep signal SLEEP. The circuit block 1 is connected to the power supply line VDD2 and a power supply line VSS (lower voltage level). The circuit block 3 is connected to the power supply line VDD1 and the power supply line VSS. The floating preventing circuit 2 is connected between the circuit block 1 and the circuit block 2 and receives the sleep signal SLEEP. An output OUT1 of the circuit block 1 is connected to an input IN2 of the circuit block 3 through the floating preventing circuit 2.

FIG. 2 is a circuit diagram showing a configuration of the floating preventing circuit 2 in detail. The floating preventing circuit 2 includes a clocked inverter 5, an NMOS transistor 6 and a CMOS inverter 7. The NMOS transistor 6 receives the sleep signal at its gate, is connected to an output node of the clocked inverter 5 at its drain and is connected to the power supply line VSS at its source.

The clocked inverter 5 is turned on in response to activation of the sleep signal SLEEP (low level) to connect the output OUT1 of the circuit block 1 to the input IN 2 of the circuit block 3 through the inverter 7. The clocked inverter 5 is turned off in response to deactivation of the sleep signal SLEEP (high level) to disconnect connection between the output OUT1 of the circuit block 1 and the input IN2 of the circuit block 3.

The NMOS transistor 6 is turned off when receiving the activated sleep signal SLEEP (low level) at its gate to disconnect the connection between an input node of the CMOS inverter 7 and the power supply line VSS (normal operation mode). The NMOS transistor 6 is turned on when receiving the deactivated sleep signal SLEEP (high level) at its gate to fix the input of the CMOS inverter 7 to a low level (sleep mode). At this time, the switch 4 disconnects the connection between the power supply line VDD1 and the power supply line VDD2. For this reason, while the power supply voltage VDD1 is not supplied from the power supply line to the circuit block 1, the input of the CMOS inverter 7 is fixed to the power supply voltage VSS. Accordingly, the floating preventing circuit can fix the input IN2 of the circuit block 3 to the high level in synchronization with switching from a normal operation mode to the sleep mode.

As described above, even when a power supply voltage is not supplied to the circuit block 1, the input IN2 to the circuit block 3 is not in a floating state. For this reason, a through-current can be prevented from flowing through the circuit block 3. In addition, since malfunction due to the indefinite input level as described above can be prevented, an increase in power consumption amount can be suppressed in the sleep mode.

However, according to a technique described in PLT1, since the input IN2 to the circuit block 3 is fixed to the high level in the sleep mode, it is necessary to steadily supply a power supply voltage of a high level to the CMOS inverter 7 of the floating preventing circuit 2. For this reason, a power supply line in a turned-on state at all times must be connected to the CMOS inverter 7. In this case, the power supply line must be extended to a region where the CMOS inverter 7 is provided. The extension of power supply line causes problems such as lowering of reliability and a voltage drop.

### SUMMARY

In an aspect of the present invention, a semiconductor integrated circuit device includes: a first power supply region, power supply to which is controlled; and a second power supply region connected with a first power supply region. The first power supply region includes: a floating preventing circuit configured to fix an output voltage from the first power supply region to the second power supply region to a ground voltage in synchronization with stop of power supply.

In another aspect of the present invention, a method of designing a semiconductor integrated circuit device, includes: dividing an instance of a design object circuit into power supply regions using the a functional block data and a connection data; and when power supply to a first one of the power supply regions is controlled, and a second one of the power supply regions is connected with the first power supply region, updating the functional block data and the connection data such that a floating preventing circuit in the first power supply region. The floating preventing circuit fixes an output voltage from the first power supply region to the second power supply region to a ground voltage in synchronization with stop of power supply to the first power supply region.

In still another aspect of the present invention, a computer-readable recording medium in which a computer-executable program is recorded to attain a method of designing a semiconductor integrated circuit device which includes:

dividing an instance of a design object circuit into power supply regions using the a functional block data and a connection data; and

when power supply to a first one of the power supply regions is controlled, and a second one of the power supply regions is connected with the first power supply region, updating the functional block data and the connection data such that a floating preventing circuit in the first power supply region. The floating preventing circuit fixes an output voltage from the first power supply region to the second power supply region to a ground voltage in synchronization with stop of power supply to the first power supply region.

In further still another aspect of the present invention, a semiconductor integrated circuit design supporting apparatus includes:

a storage section configured to store a functional block data and a connection data;

a power supply region dividing section configured to divide a design object circuit into power supply regions by using the functional block data and the connection data, wherein a first one of the power supply regions in which power supply is controlled is connected with a second one of the power supply regions; and

a floating preventing circuit inserting section configured to update the functional block data and the connection data to insert a floating preventing circuit in the first power supply region,

wherein the floating preventing circuit fixes an output voltage from the first power supply region to the second power supply region to a ground voltage in synchronization with stop of the power supply to the first power supply region.

In a semiconductor integrated circuit device, a method for designing the semiconductor integrated circuit device, a semiconductor integrated circuit device design supporting apparatus according to the present invention, a power consumption amount of the semiconductor integrated circuit device having a plurality of power supply regions can be reduced.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram showing a configuration of a semiconductor integrated circuit device according to a conventional technique;

FIG. 2 is a circuit diagram showing a configuration of a floating preventing circuit according to the conventional technique;

FIG. 3 is a block diagram showing a configuration of a semiconductor integrated circuit device according to a first embodiment of the present invention;

FIG. 4 is a circuit diagram showing a configuration of a floating preventing circuit according to the first embodiment of the present invention;

FIG. 5 is a view showing a configuration of a semiconductor integrated circuit device design supporting apparatus according to the present invention;

FIG. 6 is a block diagram showing a configuration of the semiconductor integrated circuit device design supporting apparatus at a floating preventing circuit insertion operation according to the present invention;

FIG. 7 is a view showing an example of tree structure information generated according to the present invention;

FIG. 8 is a flow chart showing an operation of floating preventing circuit insertion processing according to the first embodiment of the present invention;

FIG. 9 is a block diagram showing a configuration of a semiconductor integrated circuit device according to a second embodiment of the present invention;

FIG. 10 is a circuit diagram showing a configuration of a floating preventing circuit according to the second embodiment of the present invention; and

FIG. 11 is a flow chart showing an operation of floating preventing circuit insertion processing according to the second embodiment of the present invention.

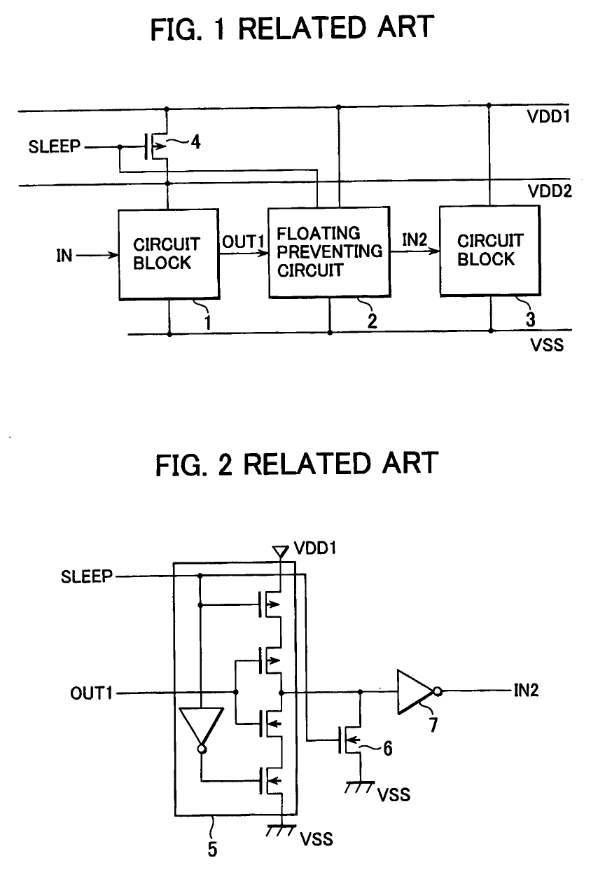

### DESCRIPTION OF THE PREFERRED EMBODIMENTS

Hereinafter, an apparatus for supporting design of a semiconductor integrated circuit device according to the present invention will be described below with reference to the attached drawings.

### First Embodiment

### (Semiconductor Integrated Circuit Device)

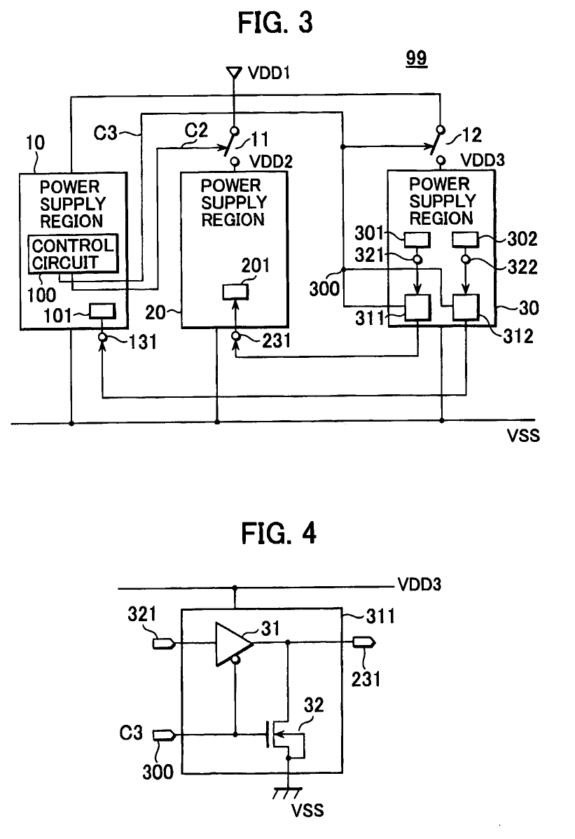

Referring to FIGS. 3 and 4, a semiconductor integrated circuit device according to a first embodiment of the present invention will be described. FIG. 3 is a block diagram showing a configuration of the semiconductor integrated circuit device 99 according to the first embodiment. The semiconductor integrated circuit device 99 is divided into three power supply regions 10, 20 and 30 and has switches 11 and 12 for switching an operation mode, based on which power consumption is controlled.

The power supply region 10 is a region having circuit blocks (for example, a control circuit 100 and a circuit block 101) connected to a power supply node VDD1 to which a power supply voltage VDD1 (high level) is supplied and a power supply node VSS to which the power supply voltage VSS (low level) is supplied. A circuit block in the power supply region 10 is driven with the power supply voltage VDD1. Here, the power supply voltage VDD1 is supplied to the power supply node VDD1 at all times. For this reason, the circuit blocks in the power supply region 10 operate in a power saving mode in the same manner as in a normal operation mode. The control circuit 100 outputs control signals C2 and C3 (enable signals) for controlling ON/OFF of the switches 11 and 12. It is preferred that the control circuit 100 is provided in the power supply region 10 to which the power supply voltage VDD1 is supplied at all times. In this case, the control circuit 100 can control the switches 11 and 12 at all times, to switch the operation mode of the power supply regions 20 and 30.

The power supply region 20 is a region having a circuit block (for example, a circuit block 201) connected to a power supply node VDD2 and the power supply node VSS. The power supply node VDD2 is connected to the power supply node VDD1 via the switch 11, and when the switch 11 is turned on, the power supply voltage VDD1 is supplied. The switch 11 is turned on in response to the control signal C2 of a low level and the circuit block in the power supply region 20 is driven with the power supply voltage VDD1 (normal mode). On the other hand, the switch 11 is turned off in response to the control signal C2 of a high level and the circuit block in the power supply region 20 stops (power saving mode).

The power supply region 30 is a region having circuit blocks (for example, circuit blocks 301 and 302, floating preventing circuits 311 and 312) connected to a power supply node VDD3 and a power supply node VSS. The power supply node VDD3 is connected to the power supply node VDD1 via the switch 12, and when the switch 12 is turned on, the power supply voltage VDD1 is supplied. The switch 12 is turned on in response to a control signal C3 of a low level and the circuit blocks in the power supply region 30 are driven with the power supply voltage VDD1 (normal mode). On the other hand, the switch 12 is turned off in response to the control signal C3 of a high level and the circuit blocks in the power supply region 30 stop (power saving mode).

Since the control signals C2 and C3 are separate control signals, the power supply regions 20 and 30 can change the operation mode at any time. The switches 11 and 12 may be connected to the power supply node to which a power supply voltage different from the power supply voltage VDD1 is supplied.

The circuit blocks 301 and 302 in the power supply region 30, power supply of which is controlled by the switch 12, are connected to the circuit blocks 201 and 101 in other power supply regions via the floating preventing circuit 311 and 312, respectively. The floating preventing circuit 311 outputs a signal outputted from the circuit block 301 (node 321) to the circuit block 201 (node 231). The floating preventing circuit 312 outputs a signal outputted from the circuit block 302 (node 322) to the circuit block 101 (node 131).

The control signal C3 is supplied to the floating preventing circuits 311 and 312 via a node 300. The floating preventing circuits 311 and 312 fixes output voltages supplied to the circuit block 201 (node 231) and the circuit block 101 (node 131) to the power supply voltage VSS of the low level (for example, ground voltage) in response to the control signal C3 for turning off the switch 12 (here, the control signal C3 of the high level), respectively.

Referring to FIG. 4, the configuration of the floating preventing circuit 311 in the first embodiment will be described in detail. Since the configuration of the floating preventing circuit 312 is the same as that of the floating preventing circuit 311, description thereof is omitted.

The floating preventing circuit 311 includes a tri-state buffer 31 and an NMOS transistor 32 (switch circuit). An input of the tri-state buffer 31 is connected to an output of the circuit block 301 in the power-supply region 30 via a node 321 and an output of the tri-state buffer 31 is connected to the circuit block 201 (node 231) in the power supply region 20. Furthermore the tri-state buffer 31 is connected to the power supply node VSS in the power supply region 30 to which the tri-state buffer 31 belongs to, and when the switch 11 is turned on, the power supply voltage VDD1 is supplied. The NMOS transistor 32 is connected to the node 300 at its gate, connected to an output of the tri-state buffer 31 (node 231) at its drain and connected to the power supply node VSS at its source.

Next, referring to FIGS. 3 and 4, an operation of the semiconductor integrated circuit device 99 in the first embodiment will be described in detail.

When the control signal C3 of the high level is outputted from the control circuit 100, the switch 12 is brought into an opened state and power supply to the power supply region 30 stops (power saving mode). Thus, the power supply region 30 is in a deactivated state and the output voltage of the tri-state buffer 31 has an indefinite value. Meanwhile, the NMOS transistor 32 is put into an ON state, and the node 231 is connected to the power supply node VSS. For this reason, a voltage of the node 231 is fixed at the power supply voltage VSS of the low level.

That is, in a power saving mode of deactivating the power supply region 30, the floating preventing circuit 311 fixes the output voltage from the circuit block 301 in the power supply region 30 to the circuit block 201 (node 231) in the power supply region 20 to the power supply voltage VSS of the low level. Similarly, in the power saving mode, the floating preventing circuit 312 fixes the output voltage from the circuit block 302 in the power supply region 30 to the circuit block 101 (node 131) in the power supply region 10 to the power supply voltage VSS of the low level.

As described above, even when power supply is stopped, the floating preventing circuits 311 and 312 in the present embodiment can fix the output voltages to the power supply regions 20 and 10 to the power supply voltage VSS of the low level. For this reason, it is not necessary to supply the power supply voltage to the floating preventing circuits 311 and 312 at all times. Furthermore, in synchronization with stop of the power supply to the power supply region 30, the floating preventing circuits 311 and 312 fix the output voltages to the other power supply regions to the power supply voltage VSS of the low level. For this reason, the floating preventing circuits 311 and 312 can be incorporated into the power supply region 30, power supply of which is controlled in response to the control signal C3.

In addition, regardless of whether the connected power supply region is the power supply region 20, power supply of which is controlled, or the power supply region 10 to which power is supplied at all times, the floating preventing circuit in the present embodiment can fix the output voltage to the connected power supply region to the power supply voltage VSS. Furthermore, since an NMOS transistor is used to lower the output voltage to the power supply voltage VSS (low level) for prevention of floating, it is not necessary to draw the power supply line in the ON state at all times to the region of the floating preventing circuit.

On the other hand, when the control signal C3 of the low level is outputted from the control circuit 100, the switch 12 is closed and the power supply voltage VDD1 is supplied to the power supply region 30 (power supply node VDD3), so that the power supply region 30 is activated (normal mode). At this time, the NMOS transistor 32 is set to the OFF state in response to the control signal C3 of the low level, to release connection between the power supply node VSS and the output of the tri-state buffer 31. In response to the control signal C3 as an enable signal, the tri-state buffer 31 outputs a signal received from the node 321 (circuit block 301) to a node 232 (circuit block 201).

Similarly, in the normal mode, the floating preventing circuit 312 outputs an output signal from the node 322 (circuit block 302) to the node 131 (circuit block 101).

As described above, in the normal mode, the floating preventing circuits 311 and 312 pass the output voltages to the other power supply regions. That is, in the normal mode, the circuit blocks 301 and 302 in the power supply region 30 can output the output signals to the circuit blocks in the power supply regions 20 and 10.

With the semiconductor integrated circuit device according to the present invention, since the output voltage from the power supply region to which power is not supplied in the power saving mode to the other power supply region can be fixed to the power supply voltage VSS of the low level (for example, ground voltage), the power consumption amount can be further reduced.

### (Semiconductor Integrated Circuit Device Design Supporting Apparatus)

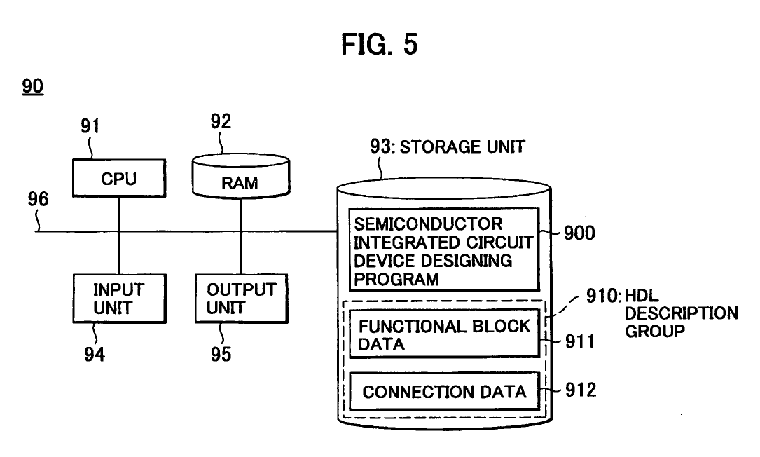

Referring to FIGS. 5 to 8, a semiconductor integrated circuit device design supporting apparatus for supporting design of the semiconductor integrated circuit device according to the present invention will be described. FIG. 5 is a block diagram showing a configuration of the semiconductor integrated circuit device design supporting apparatus 90 according to an embodiment of the present invention. Referring to FIG. 5, the semiconductor integrated circuit device design supporting apparatus 90 includes a CPU 91, a RAM 92, a storage unit 93, an input unit 94 and an output unit 95 which are connected to each other via a bus 96. The storage unit 93 is an external storage unit such as a hard disc and a memory. The input unit 94 is operated by the user by use of a keyboard, a mouse or the like to output various data to the CPU 91 and the storage unit 93. The output unit 95 is a monitor or a printer, which visually outputs a circuit design result outputted from the CPU 91 to the user.

The CPU 91 executes the semiconductor design program 900 in the storage unit 93 in response to an instruction from the input unit 94, to execute a circuit design process (here, a floating preventing circuit inserting process). At this time, various data and program sent from the storage unit 93 are temporarily stored in the RAM12 and the CPU11 executes various processes by using the data stored in the RAM 12.

The storage unit 93 stores the semiconductor design program 900 and HDL (Hardware Description Language) description group 910 therein. The semiconductor design program 900 is installed from a recording medium (not shown) into the storage unit 93 and has a function designing tool and a logic synthesizing tool. The HDL description group 910 has function block data 911 designed in HDL description generated by the function designing tool and connection data 912 in a circuit.

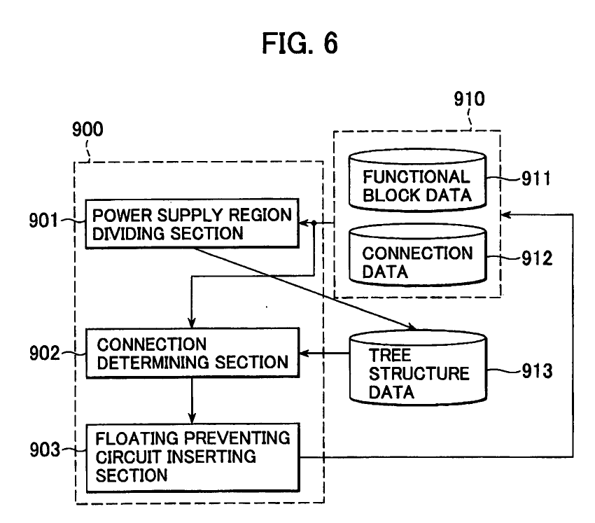

FIG. 6 is a function block diagram of the semiconductor integrated circuit device design supporting apparatus 90 in insertion of the floating preventing circuit. Referring to FIG. 6, the semiconductor design program 900 is executed by the CPU 91 to function as a power supply region dividing section 901, a connection determining section 902 and a floating preventing circuit inserting section 903.

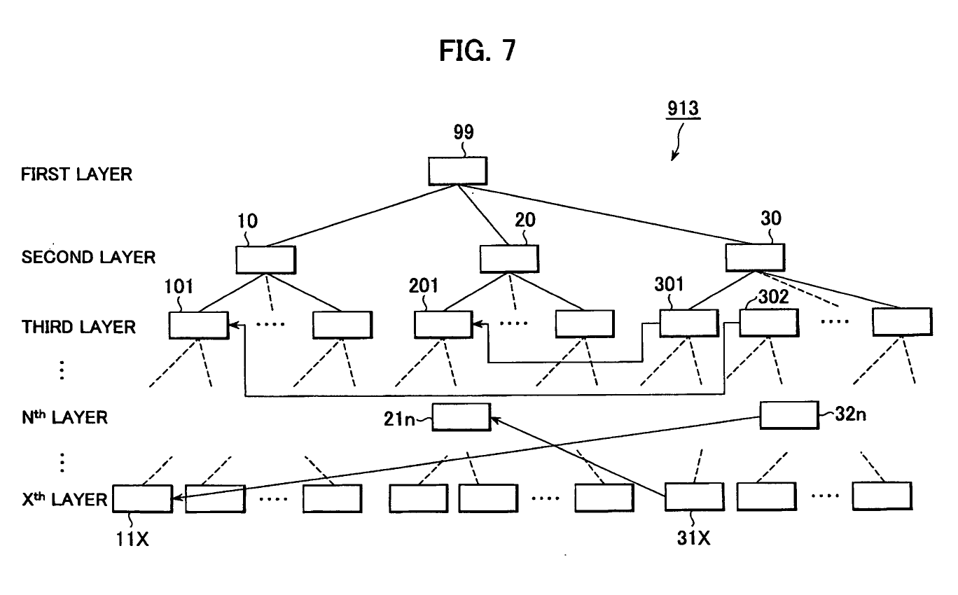

By using the function block data 911 and the connection data 912 of the circuit to be designed, the power supply region dividing section 901 generates a tree structure data 913 in which the circuit is divided into power supply regions. Describing in detail, the power supply region dividing section 901 divides the semiconductor integrated circuit device subjected to a function design into the power supply regions and layers circuit blocks in each power supply region. FIG. 7 shows an example of the tree structure data 913. As shown in FIG. 7, the power supply region dividing section 901 divides the semiconductor integrated circuit device 99 subjected to the function design into three power supply regions 10, 20 and 30 and layers the circuit blocks provided in each power supply region. At this time, the semiconductor integrated circuit device 99 is set as a first layer and the power supply region 10, 20 and 30 are set as a second layer. Then, each of the circuit blocks included in the power supply region 10 is sub-divided into a plurality of circuit components and is layered into a third to an X^{th} layers. Thus, in the tree structure data 913, as the layer becomes lower, circuit scale of the circuit component is made smaller. For example, the circuit blocks 101, . . . in the third layer are subdivided into the circuit components 11X, . . . of a gate level in the X^{th} layer. Similarly, the power supply regions 20 and 30 are layered into the third to the X^{th} layers.

The power supply region dividing section 901 also inserts a connection between the circuit blocks into the tree structure data 913 on the basis of the connection data 912. In an example shown in FIG. 7, the circuit block 301 is connected to the circuit block 201 and the circuit block 302 is connected to the circuit block 101 in the semiconductor integrated circuit device 99 in the third hierarchy. Describing in detail, a circuit component 31X in the X^{th} layer which belongs to the circuit block 301 is connected to a circuit component 21n in an n^{th} layer which belongs to the circuit block 201. The circuit component 32n in the n^{th} layer which belongs to the circuit block 302 is connected to the circuit component 11n in the X^{th} layer which belongs to the circuit part 101.

The connection determining section 902 selects a concerned circuit block (circuit component) from the HDL description group 910 and identifies the power supply region to which the circuit component belongs by using the tree structure data 913. For example, referring to FIG. 7, when the power supply region to which the circuit component 31X belongs is identified, the connection determining section 902 refers to the tree structure data 913 to track a path from the circuit component 31X toward the upper layer and identifies that the circuit component 31X is a circuit component in the circuit block 301 in the third layer. The connection determining section 902 further tracks the path from the circuit component 31X toward the upper layer and identifies that the circuit component 31X is provided in the power supply region 30 in the second layer. It should be noted that it is preferred that the connection determining section 902 is realized by the logic synthesizing tool.

The connection determining section 902 also detects a circuit block connected to the selected circuit component and identifies the power supply region to which the detected circuit block belongs. For example, referring to FIG. 7, when the circuit component 31X is connected to the circuit component 21n, the connection determining section 902 identifies that the circuit component 21n belongs to the power supply region 20, as described above. This identification result is informed to the floating preventing circuit inserting section 903. In this case, the fact that the circuit component 31X is connected to the circuit component 21n belonging to the power supply region 20 is informed to the floating preventing circuit inserting section 903.

The floating preventing circuit inserting section 903 updates the HDL description group 910 based on the identification result informed from the connection determining section 902, so that the floating preventing circuit is inserted between the circuit blocks (circuit components) in different power supply regions which are connected to each other. For example, when the circuit component 31X is connected to the circuit component 21n, the floating preventing circuit is connected between the circuit component 31X and the circuit component 21n. When an output of the circuit component 31X is connected to an input of the circuit component 21n, it is preferred that the floating preventing circuit is provided in the power supply region 30 to which the circuit component 31X belongs. The floating preventing circuit which uses a power supply of the circuit component 31X (circuit block 301) can fix the output voltage from the circuit component 31X (circuit block 301) to the circuit component 21n (circuit block 201) to a low level. In addition, it is preferred that the floating preventing circuit inserting section 903 updates the HDL description group 910 by using the floating preventing circuit prepared as a circuit block in HDL description. By preparing the floating preventing circuit as one circuit block, the semiconductor integrated circuit device having the floating preventing circuit can be easily designed according to a method described later.

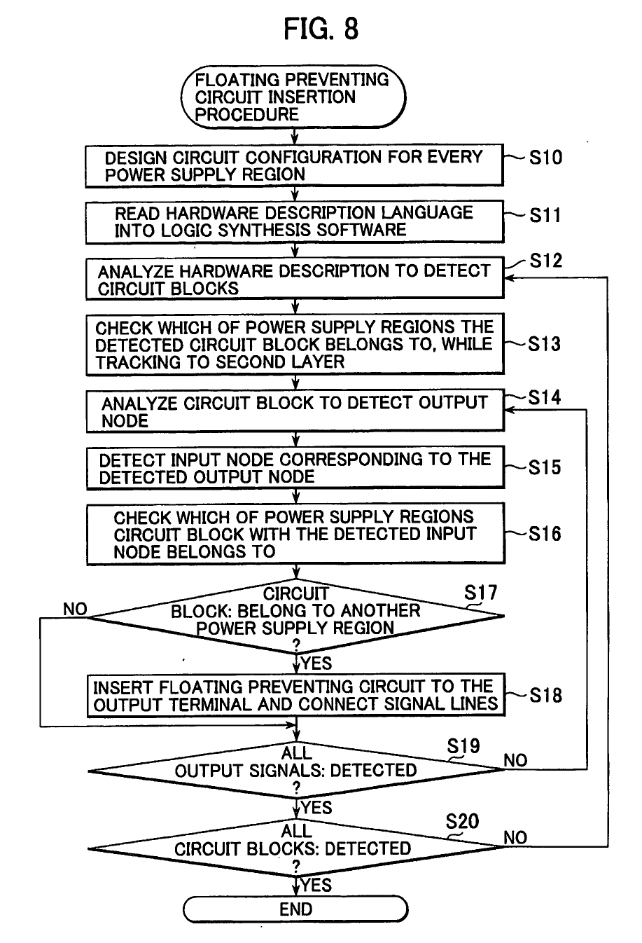

FIG. 8 is a flow chart showing an operation of the floating preventing circuit inserting process by the semiconductor integrated circuit device design supporting apparatus 90 according to the first embodiment. Referring to FIGS. 3, 7 and 8, the floating preventing circuit inserting process in the present embodiment will be described in detail.

First, a circuit to be designed is divided into power supply regions so as to have a tree structure (Step S10). At this time, the tree structure data 913 of the circuit to be designed is generated based on the HDL description group 910.

The connection determining section 902 reads the HDL description group 910 (Step S11). The connection determining section 902 analyzes the read HDL description group 910 and detects the circuit components (circuit blocks) in order from a bottom layer in the tree structure data 913 (Step S12). Here, it is assumed that the circuit component 31X is detected. The connection determining section 902 checks which of the power supply regions the detected circuit component 31X belongs to by using the tree structure data 913 and tracking back to the second layer (Step S13). Here, it is found that the circuit component 31X is provided in the circuit block 301 in the power supply region 30.

The connection determining section 902 analyzes the detected circuit block and detects an output node (Step S14). Here, the node 321 is detected as the output node of the circuit component 31X (circuit block 301). Next, an input node connected to the detected output node is detected (Step S15). Here, the node 231 is detected as the input node connected to the node 321. The connection determining section 902 checks which of the power supply regions the circuit block having the detected input node belongs to (Step S16). Referring to the tree structure data 913, the connection determining section 902 identifies that the circuit component 21n having the input node 231 belongs to the power supply region 20.

When the power supply region to which the circuit block having the input node belongs is different from the power supply region to which the circuit block having the output node belongs, the floating preventing circuit is inserted between the circuit blocks (Yes at Step S17, S18). Here, as shown in FIG. 3, since the power supply region 20 to which the circuit component 21n (circuit block 201) belongs is different from the power supply region 30 to which the circuit component 31X (circuit block 301) belongs, the floating preventing circuit 311 is inserted between the circuit block 201 (node 231) and the circuit block 301(node 231). At this time, the HDL description group 910 is updated so that the floating preventing circuit 311 is connected between the node 231 and the node 321 and is provided in the power supply region 30. Then, a procedure proceeds to Step S19. When the power supply region to which the circuit block having the input node belongs is the same as the power supply region to which the circuit block having the output node belongs, or when the floating preventing circuit has been inserted between these nodes, the procedure proceeds to Step S19 (No at Step S17).

At Step S19, existence/nonexistence of the output node connected to an unidentified power supply region is checked. Here, when all output nodes in the circuit block are not checked, the process from Step S14 to Step S19 is repeated. Thus, for all the output nodes in the circuit block, identification of the connected power supply region and insertion of the floating preventing circuit are performed (No at Step S19). When all the output nodes in the circuit block have been checked, the procedure proceeds to Step S12 to perform identification of the connected power supply region and insertion of the floating preventing circuit for another circuit block (Yes at Step S19, No at Step 20).

The above-mentioned flow is performed in order from the bottom layer in the tree structure data 913. For example, as described above, when it is detected that the circuit component 32n in the n^{th} layer is connected to the circuit component 11X, since the power supply region 30 to which the circuit component 32n belongs is different from the power supply region 10 to which the circuit component 11X belongs, the floating preventing circuit is inserted between the circuit component 32n and the circuit component 11X. Here, as shown in FIG. 3, the floating preventing circuit 312 is inserted between the node 322 of the circuit block 302 to which the circuit component 32n belongs and the node 131 of the circuit block 101 to which the circuit component 11X belongs.

At Step S20, the above-mentioned verification is ended for all the circuit blocks detected based on the HDL description group 910, the semiconductor integrated circuit device design supporting apparatus 90 ends the floating preventing circuit inserting process. According to the above-mentioned operation, the HDL description group 910 on the semiconductor integrated circuit device 99 is updated.

As described above, according to the present invention, the floating preventing circuit can be automatically inserted between the connection nodes in different power supply regions to design the semiconductor integrated circuit device 99 shown in FIG. 3. That is, in design in case of separated power supplies, the conventional problem of propagation of indefinite signal can be solved and the design can be automated. At this time, since the floating preventing circuit is automatically inserted while being controlled by the logic synthesizing tool, time for design is reduced.

### Second Embodiment

### (Semiconductor Integrated Circuit Device)

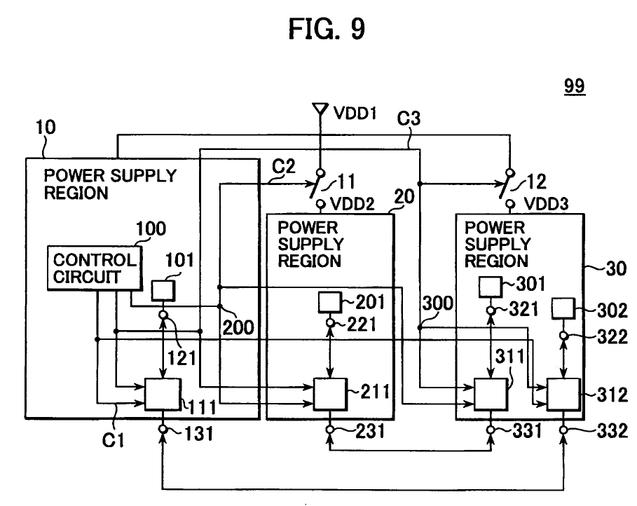

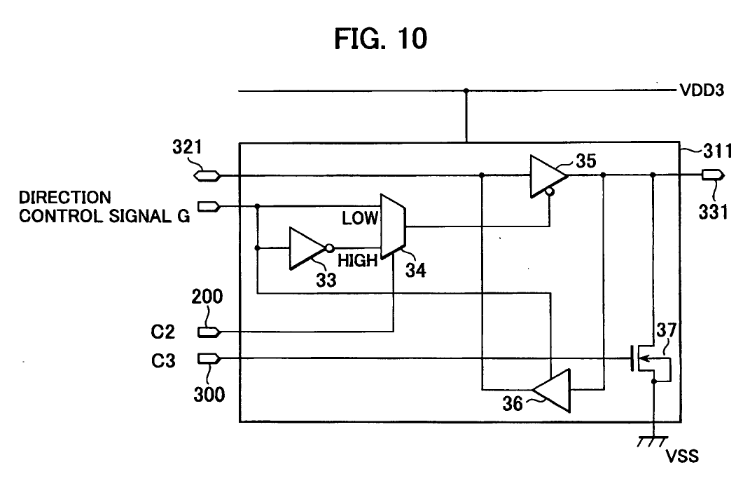

Referring to FIGS. 9 and 10, a semiconductor integrated circuit device according to a second embodiment of the present invention will be described. FIG. 9 is a block diagram showing a configuration of the semiconductor integrated circuit device 99 in the second embodiment. Although the semiconductor integrated circuit device in the first embodiment fixes the output voltage from the power supply region to which power is not supplied to the other power supply region to the power supply voltage VSS of the low level, the semiconductor integrated circuit device in the second embodiment fixes a bidirectional signal between different power supply regions to the power supply voltage VSS of the low level. The floating preventing circuit in the second embodiment is provided for each of the different interconnected power supply regions, and when the power supply region to which a circuit block belongs is in a power saving mode, the output voltage from the circuit block to the power supply region in the normal mode is fixed to the power supply voltage VSS. Furthermore, in the floating preventing circuit in the second embodiment, if the connected power supply region is in the power saving mode even when the power supply region to which a circuit block belongs is in the normal mode, the output to the connected power supply region is disconnected. In the following description, only configuration and operation which are different from those in the first embodiment will be described.

Floating preventing circuits 111 and 211 are provided in the power supply regions 10 and 20, respectively. The floating preventing circuit 111 is connected between the circuit block 101 (node 121) and the floating preventing circuit 312 (node 332) in the power supply region 30. The floating preventing circuit 211 is connected between the circuit block 201 (node 221) and the floating preventing circuit 311 (node 331) in the power supply region 30. The control signal C2 for controlling power supply to the power supply region 20 to which the floating preventing circuit 211 belongs and the control signal C3 for controlling power supply to the connected power supply region 30 are supplied to the floating preventing circuit 211.

The floating preventing circuit 311 provided in the power supply region 30 is connected between the circuit block 301 (node 321) and the floating preventing circuit 211 (node 231) in the power supply region 20. The control signal C3 for controlling power supply to the power supply region 30 to which the floating preventing circuit 311 belongs and the control signal C2 for controlling power supply to the connected power supply region 20 are supplied to the floating preventing circuit 311. The floating preventing circuit 312 is connected to the circuit block 302 (node 322) and the floating preventing circuit 111 (node 131) in the power supply region 10. The control signal C3 for controlling power supply to the power supply region 30 to which the floating preventing circuit 311 belongs and the control signal C1 for controlling power supply to the power supply region 10 are supplied to the floating preventing circuit 311.

As in the first embodiment, the control circuit 100 outputs the control signals C2 and C3 for controlling the switches 11 and 12 to control power supply to the power supply regions 20 and 30, as well as outputs the control signal C1 to the floating preventing circuits 111 and 312. The control signal C1 is a dummy signal corresponding to the control signals C2 and C3 for controlling power supply. Since the floating preventing circuit 111 is provided in the power supply region 10 to which power is supplied at all times, the control signal C1 of a low level is supplied at all times. The node 131 is connected to the node 332 and the node 231 is connected to the node 331 via bidirectional signal lines, respectively.

Referring to FIG. 10, a configuration of the floating preventing circuit 311 in the second embodiment will be described in detail. Since configuration of the floating preventing circuits 111, 211, and 312 are the same as that of the floating preventing circuit 311, description thereof is omitted.

The floating preventing circuit 311 includes an inverter 33, a two-input selector 34, tri-state buffers 35 and 36 and an NMOS transistor 37 (switch circuit). The control signals C2 and C3 and a direction control signal G are supplied to the floating preventing circuit 311. The inverter 33 outputs an inverted signal of the direction control signal G to the two-input selector 35. The two-input selector 35 selects one of the direction control signal and the inverted signal based on the control signal C2 supplied from the node 200 and outputs the selected signal as an enable signal for the tri-state buffer 35. The tri-state buffer 35 is connected between the node 321 and the node 311 and controls transmission of the output signal from the node 321 to the node 311 based on the enable signal. The direction control signal G is supplied to the tri-state buffer 36 as an enable signal. The tri-state buffer 36 is connected between the node 331 and the node 321 and controls transmission of the output signal from the node 331 to the node 321 based on the enable signal. The tri-state buffer 35 and the tri-state buffer 36 are enabled in a reversed phase. The NMOS transistor 37 is connected to the node 300 at its gate, is connected to an output of the tri-state buffer (node 231) at its drain and is connected to the power supply node VSS at its source.

Next, referring to FIGS. 9 and 10, an operation of the semiconductor integrated circuit device 99 in the second embodiment will be described in detail.

When the control signal C3 of the high level is outputted from the control circuit 100, the switch 12 is set to an opened state and power supply to the power supply region 30 stops (power saving mode). Thus, the power supply region 30 is deactivated and the output voltage of the tri-state buffer 35 has an indefinite value. Meanwhile, the NMOS transistor 37 is turned on according to the control signal C3 of the high level, to connect the node 331 to the power supply node VSS. For this reason, a voltage at the node 331 (output voltage C23) is fixed to the power supply voltage VSS of the low level.

That is, in the power saving mode in which the power supply region 30 is deactivated, the floating preventing circuit 311 fixes the output voltage from the circuit block 301 in the power supply region 30 to the circuit block 201 (node 231) in the power supply region 20 to the power supply voltage VSS of the low level. Similarly, in the power saving mode, the floating preventing circuit 312 fixes the output voltage from the circuit block 302 in the power supply region 30 to the circuit block 101 (node 131) in the power supply region 10 to the power supply voltage VSS of the low level.

Similarly, in the power saving mode in which the power supply region 20 is deactivated, the floating preventing circuit 211 fixes the output voltage from the circuit block 201 in the power supply region 20 to the circuit block 301 (node 331) in the power supply region 30 to the power supply voltage VSS of the low level.

As described above, even when power supply is stopped, the floating preventing circuits 311 and 312 in the present embodiment can fix the output voltages to the power supply regions 20 and 10 to the power supply voltage VSS of the low level. For this reason, it is necessary to supply the power supply voltage to the floating preventing circuits 311 and 312 at all times. Furthermore, the floating preventing circuits 311 and 312 fixes the output voltages to the power supply voltage VSS of the low level in synchronization with stop of power supply to the power supply region 30. Thus, the floating preventing circuits 311 and 312 can be incorporated into the power supply region 30, power supply to which is controlled in response to the control signal C3. Similarly, even when power supply is stopped, the floating preventing circuit 211 can fix the output voltage to the power supply region 30 to the power supply voltage VSS of the low level. For this reason, it is necessary to supply the power supply voltage to the floating preventing circuit 211 at all times. Furthermore, the floating preventing circuit 211 fixes the output voltage to the power supply voltage VSS of the low level in synchronization with stop of power supply to the power supply region 20. Thus, the floating preventing circuits 311 and 312 can be incorporated into the power supply region 20, power supply to which is controlled in response to the control signal C2.

In addition, regardless of whether the connected power supply region is the power supply region 20 or 30, power supply of which is controlled, or the power supply region 10 to which power is supplied at all times, the floating preventing circuits in the present embodiment can fix the output voltage to the connected power supply regions to the power supply voltage VSS. Furthermore, since the NMOS transistor is used to lower the output voltage to the power supply voltage VSS (low level) for prevention of floating, it is not necessary to extend the power supply line in the ON state at all times to the region of the floating preventing circuit.

On the other hand, when the control signal C3 of the low level is outputted from the control circuit 100, the switch 12 is closed and the power supply voltage VDD1 is supplied to the power supply region 30 (power supply node VDD3), so that the power supply region 30 is activated (normal mode). At this time, the NMOS transistor 37 is set to the OFF state in response to the control signal C3 of the low level, to release connection between the power supply node VSS and an output of the tri-state buffer 35. Here, when the connected power supply region 20 is in the normal mode (the control signal C2 of a low level is supplied), if the direction control signal G of a low level is supplied, the tri-state buffer 35 is set to a conducting state, the tri-state buffer 36 is set to a high impedance state and the floating preventing circuit 311 operates as an output circuit of the circuit block 301. If the direction control signal G of the high level is supplied, the tri-state buffer 36 is set to the conducting state, the tri-state buffer 35 is set to the high impedance state and the floating preventing circuit 311 operates as an input circuit of the circuit block 301.

Furthermore, when the connected power supply region 20 is in the power saving mode (the control signal C2 of high level is supplied), since tri-state buffer 35 is set to the high impedance state even when the direction control signal of the low level is supplied, the floating preventing circuit 311 gives no output to the power supply region 20 (circuit block 201). Accordingly, even when a high level signal is received from one power supply region in an activated state, the NMOS transistor 37 is not set to the activated state, to prevent a current path from the power supply line to the ground line being formed. Thus, it is prevented that a through current flows through the NMOS transistor 37.

Similarly, when the power supply region 20 is in the power saving mode, the floating preventing circuit 211 fixes the output voltage from the node 221 (circuit block 201) to the power supply voltage VSS of the low level. When the power supply region 20 is in the power saving mode, the floating preventing circuit 312 operates as an input circuit or an output circuit of the circuit block 201 in response to the direction control signal G. At this time, when the connected power supply region 30 is in the power saving mode, the floating preventing circuit 211 gives no output to the power supply region 30 (circuit block 302).

When the power supply region 30 is in the power saving mode, the floating preventing circuit 312 fixes the output voltage from the node 322 (circuit block 302) to the power supply voltage VSS of the low level. When the power supply region 30 is in the power saving mode, the floating preventing circuit 312 operates as an input circuit or an output circuit of the circuit block 302 in response to the direction control signal G.

Since the power supply region 10 is in the normal mode at all times, the floating preventing circuit 111 operates as an input circuit or an output circuit of the node 121 (circuit block 101). At this time, when the connected power supply region 30 is in the power saving mode, the floating preventing circuit 111 gives no output to the power supply region 30 (circuit block 301).

As described above, the semiconductor integrated circuit device 99 in the second embodiment can fix the bidirectional signal between the different power supply regions to the power supply voltage VSS of the low level in the power saving mode.

The floating preventing circuit in the second embodiment is prepared as one circuit block and is utilized in designing the semiconductor integrated circuit device by the above-mentioned semiconductor integrated circuit device design supporting apparatus 90.

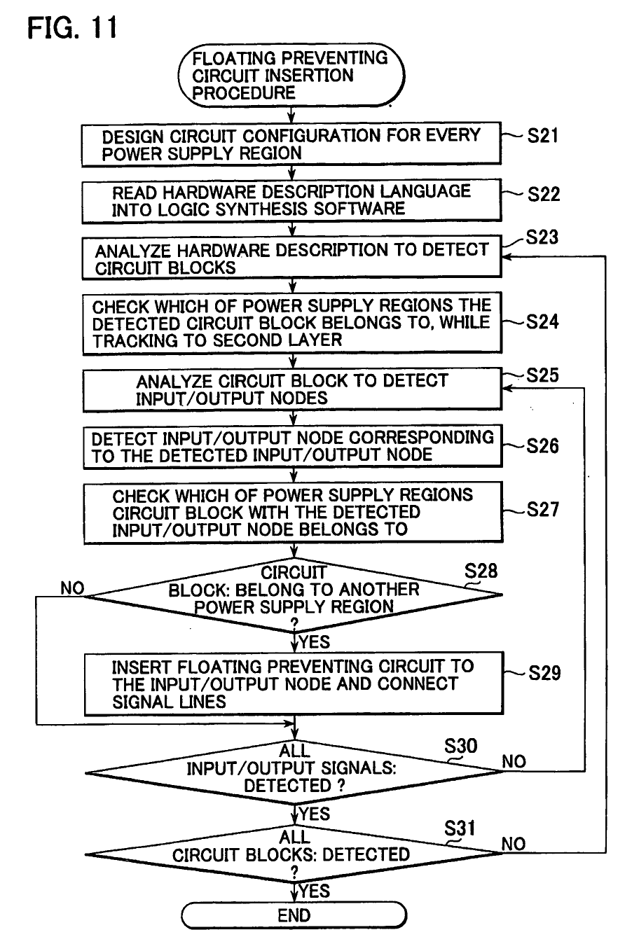

FIG. 11 is a flow chart showing an operation of floating preventing circuit inserting process by the above-mentioned semiconductor integrated circuit device design supporting apparatus 90 according to the second embodiment. Referring to FIGS. 7, 9 and 11, the floating preventing circuit inserting process in the present embodiment will be described in detail.

First, a circuit to be designed is divided into power supply regions to have the tree structure (Step S21). At this time, the tree structure data 913 of the circuit to be designed is generated based on the HDL description group 910.

The connection determining section 902 reads the HDL description group 910 (Step S22). The connection determining section 902 analyzes the read HDL description group 910 and detects the circuit components (circuit blocks) from the bottom layer in the tree structure data 913 (Step S23). Here, it is assumed that the circuit component 31X is detected. The connection determining section 902 checks which of the power supply regions the detected circuit component 31X belongs to, by using the tree structure data 913 and tracking back to the second layer (Step S24). Here, it is found that the circuit component 31X is provided in the circuit block 301 in the power supply region 30.

The connection determining section 902 analyzes the detected circuit block and detects an input/output node (Step S25). Here, the node 321 is detected as the input/output node of the circuit component 31X (circuit block 301). Next, an input/output node connected to the detected input/output node is detected (Step S26). Here, the node 231 is detected as an input/output node connected to the node 321. The connection determining section 902 checks which of power supply regions the circuit block having the detected input node belongs to (Step S27) Referring to the tree structure data 913, the connection determining section 902 identifies that the circuit component 21n having the node 231 belongs to the power supply region 20.

When the power supply region to which the connected circuit block belongs is different from the power supply region to which the detected circuit block belongs, the floating preventing circuit is inserted between the circuit blocks (Yes at Step S28, S29). Here, since the power supply region 20 to which the circuit component 21n (circuit block 201) belongs is different from the power supply region 30 to which the circuit component 31X (circuit block 301) belongs, the floating preventing circuit 311 is inserted between the circuit block 201 (node 231) and the circuit block 301 (node 231). At this time, the HDL description group 910 is updated so that the floating preventing circuit 311 is connected between the node 231 and the node 321 and is provided in the power supply region 30. Then, the procedure proceeds to Step S30. When the power supply region to which the connected circuit block belongs is the same as the power supply region to which the detected circuit block belongs, or when the floating preventing circuit is inserted between these nodes in the power supply region to which the detected circuit block belongs, the procedure proceeds to Step S30 (No at Step S28).

At Step S30, existence/nonexistence of the output node connected to an unidentified power supply region is checked. Here, when all the input/output nodes in the circuit block have been not yet checked, the process from Step S25 to Step S30 is repeated. Thus, for all the input/output nodes in the circuit block, identification of the connected power supply region and insertion of the floating preventing circuit are performed (No at Step S30). When all the output nodes in the circuit block are checked, the procedure proceeds to Step S23 and for the other circuit block, identification of the connected power supply region and insertion of the floating preventing circuit are performed (Yes at Step S30, No at Step 31).

The above-mentioned process flow is performed in order from the lower layer in the tree structure data 913. For example, as described above, when it is detected that the circuit component 32n in the n^{th} layer is connected to the circuit component 11X as shown in FIG. 9, the floating preventing circuits 211 and 311 are inserted between the circuit block 201 to which the circuit component 21n belongs and the circuit block 301 to which the circuit component 31X belongs. Furthermore, the floating preventing circuits 111 and 312 are inserted between the circuit block 302 to which the circuit component 32n belongs and the circuit block 101 to which the circuit component 11X belongs.

At Step S31, when the above-mentioned verification is ended for all the circuit blocks detected from the HDL description group 910, the semiconductor integrated circuit device design supporting apparatus 90 ends the floating preventing circuit inserting process.

As described above, according to the present invention, the floating preventing circuits can be automatically inserted between the input/output nodes in different power supply regions to design the semiconductor integrated circuit device 99 shown in FIG. 9. That is, in design in case of separated power supply, the problem of propagation of indefinite signal can be solved and the design can be automated. At this time, since the floating preventing circuit is automatically inserted while being controlled by the logic synthesizing tool, time for design is reduced.

The semiconductor integrated circuit device, the method for designing the semiconductor integrated circuit device, the semiconductor integrated circuit device design program and the semiconductor integrated circuit device design apparatus according to the present invention can reduce power consumption of the semiconductor integrated circuit device divided into the plurality of power supply region. Furthermore, power consumption of the semiconductor integrated circuit device having a plurality of power supply regions interconnected via bidirectional signal lines can be reduced. Furthermore, modification to the semiconductor integrated circuit device having a floating preventing circuit can be easily performed.

Although the embodiments of the present invention has been described in detail, a specific configuration is not limited to the above-mentioned embodiments and any modifications which does not deviate from a subject matter of the present invention fall within the scope of the present invention. The first embodiment and the second embodiment may be combined not to deviate from a subject matter of the present invention.

What is claimed is:

1. A semiconductor integrated circuit device comprising:
a first power supply region, power supply to which is controlled; and
a second power supply region connected with said first power supply region,
wherein said first power supply region comprises:
a floating preventing circuit configured to fix an output voltage from said first power supply region to said second power supply region to a ground voltage in synchronization with stop of power supply.

2. The semiconductor integrated circuit device according to claim 1, further comprising:
a control circuit configured to output a first control signal; and
a switch circuit configured to control the power supply to said first power supply region in response to the first control signal,
wherein said floating preventing circuit fixes the output voltage from said first power supply region to said second power supply region to the ground voltage in response to the first control signal.

3. The semiconductor integrated circuit device according to claim 2, wherein said first power supply region comprises a first circuit block connected through a first node with a second circuit block provided in said second power supply region, and
said floating preventing circuit is interposed between said first circuit block and said second circuit block to connect a power supply node to which the ground voltage is supplied, and said first node in response to the first control signal.

4. The semiconductor integrated circuit device according to claim 3, wherein said floating preventing circuit comprises a transistor having a gate connected with a second node to which the first control signal is supplied, a drain connected with said power supply node.

5. The semiconductor integrated circuit device according to claim 2, wherein said control circuit is provided in a power supply regional to which power is always supplied.

6. The semiconductor integrated circuit device according to claim 4, wherein said floating preventing circuit further comprises a tri-state buffer connected between said first node and a third node to which an output signal from said first circuit block is supplied, and
said tri-state buffer controls a connection between said first node and said third node in response to the first control signal.

7. The semiconductor integrated circuit device according to claim 1, wherein said control circuit outputs a second control signal to control power supply to said second power supply region, and
said floating preventing circuit controls signal transfer between said first power supply region and said second power supply region in response to the second control signal.

8. The semiconductor integrated circuit device according to claim 7, wherein said floating preventing circuit further comprises a bidirectional tri-state buffer which controls signal transfer between said first circuit block in said first power supply region and said second circuit block in said second power supply region, in response to a second control signal to control power supply to said-second power supply region.

9. A method of designing a semiconductor integrated circuit device, comprising:
dividing an instance of a design object circuit into power supply regions using the a functional block data and a connection data; and
when power supply to a first one of said power supply regions is controlled, and a second one of said power supply regions is connected with said first power supply region, updating the functional block data and the connection data such that a floating preventing circuit in said first power supply region,
wherein said floating preventing circuit fixes an output voltage from said first power supply region to said second power supply region to a ground voltage in synchronization with stop of power supply to said first power supply region.

10. The method according to claim 9, wherein said updating comprises:
selecting a first circuit block in said first power supply region;
checking whether or not a second circuit block connected with said first circuit block belongs to said second power supply region which is different from said first; and
when said second circuit block is provided in said second power supply region, inserting said floating preventing circuit between said first circuit block and said second circuit block.

11. The method according to claim 10, wherein said dividing comprises:
generating a tree structure data which shows said design object circuit as a tree structure in units of power supply regions based on the functional block data and the connection data, and
said updating comprises:
identifying one of said power supply regions in which each of said first and second circuit blocks belongs to, by using said tree structure data.

12. A computer-readable recording medium in which a computer-executable program is recorded to attain a method of designing a semiconductor integrated circuit device which comprises:
dividing an instance of a design object circuit into power supply regions using the a functional block data and a connection data; and
when power supply to a first one of said power supply regions is controlled, and a second one of said power supply regions is connected with said first power supply region, updating the functional block data and the connection data such that a floating preventing circuit in said first power supply region,
wherein said floating preventing circuit fixes an output voltage from said first power supply region to said second power supply region to a ground voltage in synchronization with stop of power supply to said first power supply region.

13. The computer-readable recording medium according to claim 12, wherein said updating comprises:
selecting a first circuit block in said first power supply region;
checking whether or not a second circuit block connected with said first circuit block belongs to said second power supply region which is different from said first; and
when said second circuit block is provided in said second power supply region, inserting said floating preventing circuit between said first circuit block and said second circuit block.

14. The computer-readable recording medium according to claim 13, wherein said dividing comprises:
generating a tree structure data which shows said design object circuit as a tree structure in units of power supply regions based on the functional block data and the connection data, and
said updating comprises:
identifying one of said power supply regions in which each of said first and second circuit blocks belongs to, by using said tree structure data.

15. A semiconductor integrated circuit design supporting apparatus comprising:
a storage section configured to store a functional block data and a connection data;
a power supply region dividing section configured to divide a design object circuit into power supply regions by using the functional block data and the connection data, wherein a first one of said power supply regions in which power supply is controlled is connected with a second one of said power supply regions; and
a floating preventing circuit inserting section configured to update the functional block data and the connection data to insert a floating preventing circuit in said first power supply region,
wherein said floating preventing circuit fixes an output voltage from said first power supply region to said second power supply region to a ground voltage in synchronization with stop of the power supply to said first power supply region.

16. The semiconductor integrated circuit design supporting apparatus according to claim 15, further comprising:
a connection determining section configured to check whether said power supply region to which a second circuit block connected to said first circuit block belongs is different from said power supply region to which said first circuit block belongs,
said floating preventing circuit inserting section inserts said floating preventing circuit between said first circuit block and said second circuit block, when said second circuit block belongs to said second power supply region.

17. The semiconductor integrated circuit design supporting apparatus according to claim 15, wherein said power supply region dividing section generates a tree structure data which showed said design object circuit as a tree structure in units of power supply regions based on the functional block data and the connection data, and
said connection determining section identifies said power supply region to which each of said first and second circuit blocks belongs, by using said tree structure data.
